(19) United States
(12) Patent Application Publication
(10) Pub. No.: US 2005/0018565 A1
(43) Pub. Date: Jan. 27, 2005

(54) Optical disk and disk drive used for the same

(75) Inventor: Toshikazu Kanaoka, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 10/781,622

(22) Filed: Feb. 20, 2004

(30) Foreign Application Priority Data
Jul. 25, 2003 (JP) 2003-280481

(51) Int. Cl. G11B 7/005; G11B 7/24

(52) U.S. Cl. 369/47.22; 369/275.3

(57) ABSTRACT

An optical disk includes a recording area divided into annular bands and further into sectors. Each sector includes alternating grooves and lands, both serving as data-recording tracks. Each groove includes an address region in which data is recorded by in-phase double wobbles. The address region includes an address selection data recording portion and individual address data recording portions. The address selection data recording portion stores data for selecting one of the individual address data recording portions to read individual address data from the selected recording portion.

### BACKGROUND OF THE INVENTION

1. Field of the Invention

The present invention relates to an optical disk, and more particularly, to the wobbled address format of an optical disk. The present invention also relates to a disk drive characterized by the process to detect the address information presented by such an optical disk. In this specification, “optical disks” refer to various types of disks, such as phase change disks (CD-RW, DVD+RW, DVD−RW, DVD-RAM, Blu-ray disks), magneto-optical disks (MO, MD), dye-containing disks (CD-R, DVD+R, DVD−R), and preformatted disks (CD-ROM, DVD-ROM)

2. Description of the Related Art

Referring to FIGS. 14-16, the structure of a typical optical disk is described below. The illustrated disk is an AS-MO (advanced storage magneto optical) disk.

For storing data, the AS-MO disk includes a recording region which is provided with a spiral “groove” (extending from the center of the disk to its circumference, or vice versa) and a spiral “land” extending along the spiral groove. As viewed radially of the disk (see FIG. 16), the groove and the land appear alternately with each other. The groove and the land make a prescribed number of turns (each turn is called a “track”) about the center of the disk.

As shown in FIG. 14, the recording area of the AS-MO disk is divided into a plurality of annular zones, or “bands”, each band including a prescribed number of tracks. In the band, the recording area is divided into sectors by radially extending lines. Accordingly, each of the tracks in the band is divided into smaller parts called “frames.” With this arrangement, it is possible to single out a frame by specifying the band, the sector and the track to which the frame belongs.

FIG. 15 shows the storage format of a track. In the illustrated example, the track is divided into (n+1) frames (i.e., frames 0˜n). Each frame is made up of 39 segments including a leading segment, or address segment, and the following 38 segments, or data segments (0˜37). The address segment includes a FCM(fine clock mark) field, a pre-buffer, a preamble (1), a sync field, an address field, a reserved field, and a post-buffer. In the address field, a frame number, a band number, a track number (1), a CRC(cyclic redundancy check) (1), a preamble (2), a resync field, a track number (2), and a CRC (2) are recorded. As known in the AS-MO disk industries, the sync and the resync fields are provided for generating a trigger signal for reading the following data, the fine clock mark is provided for separation of the segments, and the preamble is provided for recording e.g. data to differentiate between a groove and a land. As shown in FIG. 14, the frame number increases from 0 to n as proceeding clockwise along the track, while it remains the same for the frames in the same sector in the same band. Any one of the frames on the disk is located by specifying the frame number, the band number, and the track number.

FIG. 16 shows some of the tracks of the groove and the land in the address segment. Taking the groove A (Track A) for example, its lower wall surface (as viewed in FIG. 16) is formed with a first wobble, while the upper wall surface is formed with a second wobble which is offset from the first wobble in the longitudinal direction of the track, so that the two wobbles do not overlap each other in the radial direction of the disk (this is called a “staggered” layout). The first wobble carries address information including a track number and a CRC (cyclic redundancy check). The second wobble also carries the same track number and the CRC, so that the track number and the CRC are reliably detected even when the disk tilts in operation.

The address information presented by the wobbles is detected by the push-pull method. Specifically, as shown in FIG. 17, when the laser beam from the object lens 1 is reflected on a groove G (or land L), primary diffracted light 2 occurs. The beams of the primary diffracted light propagate radially of the disk, to be detected by a 2-divisional detector 3. If the spot of the focused laser beam is formed on the center of the track, the differential signal (push-pull signal) to be outputted from the detector is zero, since the laser beam is reflected on the disk in the radially symmetrical manner. Otherwise, the push-pull signal is non-zero. Based on such push-pull signals, the wobbles are detected.

The above-described wobbles in the groove are formed by using two laser beams which can be modulated and polarized independently of each other. In this manner, only one of the two facing wall surfaces can be formed with a wobble at a time (single-wobble format).

When the track pitch is relatively large (0.6 μm, for example), it is possible to use a red laser diode (wavelength λ is about 640 nm) for providing a single-wobble format. However, this does not hold when the track pitch is reduced to e.g. 0.3 μm since the laser spot produced by a red laser diode is not small enough.

One way to address the above problem may be to use a blue laser diode (wavelength λ is about 405 nm) for making the single-wobble format, since a blue laser diode can produce a smaller laser spot than a red one. In this case, it is also necessary to use a blue laser diode for the light source to perform data detection. However, the sensitivity of the detector with respect to the light of the blue laser diode is low, and much noise tends to be made, whereby a high S/N ratio does not result.

This problem is dealt with in PCT/JP03/03555 by providing a “double-wobble format” in which the facing wall surfaces of the groove are formed with a pair of in-phase wobbles. FIGS. 18 and 19 illustrate the double-wobble format.

As shown in FIG. 18, the address regions of the tracks are divided into three parts: first part 4a, second part 4b and third part 4c in the direction the laser spot proceeds. Each groove G(x) (x=n˜n+4 in the figure) is provided with the address information of its own and the address information of the previous groove. The former information is disposed at one of the three parts 4a˜4c, while the latter information is disposed at one of the remaining two parts which is on the immediate right side of the part taken by the former information. The “immediate right side” is defined as follows. The second part 4b is on the immediate right side of the first part 4a, the third part 4c on the immediate right side of the second part 4b, and the first part 4a on the immediate right side of the third part 4c (though the first part 4a is not physically located on the right side of the third part 4c).

Referring to the nth groove G(n), the address information (n) for the nth groove is provided at the third part 4c, while the address information (n−1) for the previous groove is provided at the first part 4a, which is, by the above definition, on the immediate right side of the third part 4c. Regarding the (n+1)th groove G(n+1), the address information (n+1) is provided at the second part 4b, while the previous address information (n) is provided at the third part 4c so that the address information (n) in the (n+1)th groove and the same address information (n) in the nth groove are in the same part (the third part in this case). Regarding the (n+2)th groove G(n+2), the address information (n+2) is provided at the first part 4a, while the previous address information (n+1) is provided at the second part 4b so that the address information (n+1) in the (n+2)th groove and the same address information (n+1) in the (n+1)th groove are in the same part (the second part). The same arrangement holds for the (n+3)th and the (n+4)th grooves.

With the above format, two pieces of address information are detected as the beam spot S proceeds along each groove. Of these pieces, the address information having the greater track number is selected. As noted above, two adjacent grooves are formed with the same address information. As a result, the land flanked by these two grooves is provided with in-phase wobbles, one wobble being formed in e.g. the lower wall surface of the land, the other in the upper wall surface (see the third part 4c of the land L(n), for example). Further, in the other parts, the land is provided with a single wobble (see the first part 4a and the second part 4b of the land L(n)). Thus, when the beam spot S proceeds along any one of the lands for data detection, two relatively weak output signals are obtained from the single-wobbled parts, and one relatively strong output signal is obtained from the double-wobbled part. As seen from FIG. 19, it is possible to single out the strong signal among three signals by setting two slice levels (Slice-0 and Slice-A).

In the above-described scheme, the address information relevant to the desired groove or land is given by a double-wobble format produced by a single laser beam. Thus, the track pitch can be smaller than in the single-wobble format. Further, the double-wobble format produces a stronger detection signal than the single-wobble format. Accordingly, a sufficiently high S/N ratio is obtained even when a blue laser diode is used for reading data.

The format shown in FIG. 18, however, has the following drawback. First, it is necessary to detect three pieces of address information for data reading with respect to each groove. This contributes to an increase in detection error. Second, for data reading with respect to each land, it is necessary to set two slice levels (Slice-0 and Slice-A in FIG. 19) for discarding the relatively weak signals from the single-wobbles. To realize this, the output signal level needs to be constant by using auto gain control (AGC). Also, the signal from a double-wobbled part needs to be distinguishably stronger than the signal from a single-wobbled part. These requirements tend to make the detection circuit and the detection control complicated.

As explained above, the data recoding by the in-phase double-wobbled format contributes to the reduction of the track pitch and the improvement of the S/N ratio of the detection signal. However, when the diameter of the laser spot S is larger than the track pitch P, as shown in FIG. 20 (in the illustrated case, data is recorded only in the grooves), the cross-talk of address information between the adjacent tracks occurs, thereby making it difficult to detect the desired address information correctly.

### SUMMARY OF THE INVENTION

The present invention has been proposed under the circumstances described above. It is, therefore, an object of the present invention to provide an optical disk, a disk drive and a method, whereby in-phase double-wobbled address information can be correctly read with a simple detection circuit.

According to a first aspect of the present invention, there is provided an optical disk comprising: a recording area divided into a plurality of annular bands, each band being circumferentially divided into a plurality of sectors; a plurality of grooves provided in each sector and serving as data-recording tracks; and a plurality of lands provided in each sector and serving as data-recording tracks, the lands alternating with the grooves radially of the disk. Each groove comprises an address region in which data is recorded by in-phase double wobbles, the address region including an address selection data recording portion and a plurality of individual address data recording portions arranged along each groove. The address selection data recording portion stores data to select one of the individual address data recording portions for reading individual address data from the selected portion. (“Disk 1”)

Preferably, the above disk (“Disk 1”) may further have the following features. Specifically, the plurality of grooves comprise a first groove, a second groove adjacent to the first groove, and a third groove adjacent to the second groove. The plurality of individual address data recording portions of these grooves comprise three individual address data recording portions. In the first groove, one of the three individual address data recording portions stores address data of the first groove. In the second groove, one of the three individual address data recording portions stores the address data of the first groove, while another individual address data recording portion stores address data of the second groove. In the third groove, one of the three individual address data recording portions stores the address data of the second groove, while another individual address data recording portion stores address data of the third groove. The individual address data recording portion of the first groove that stores the address data of the first groove is adjacent radially of the disk to the individual address data recording portion of the second groove that stores the address data of the first groove. Further, the individual address data recording portion of the second groove that stores the address data of the second groove is adjacent radially of the disk to the individual address data recording portion of the third groove that stores the address data of the second groove. (“Disk 2”)

Preferably, the above disk (“Disk 2”) may further have the following features. Specifically, each groove comprises resync patterns adjacent to the three individual address data recording portions. The resync patterns corresponding to the two individual address data recording portions in which address data is stored are opposite in phase to the resync pattern corresponding to the remaining individual address data recording portion. (“Disk 3”)

Preferably, the above disk (“Disk 3”) may further have the following features. Specifically, the remaining individual address data recording portion is formed with an in-phase double-wobbled pattern which is irrelevant to the address data stored in two individual address data recording portions mentioned above. (“Disk 4”)

Preferably, the above disk (“Disk 4”) may further have the following features. Specifically, the irrelevant in-phase double-wobbled pattern of each groove is opposite in phase to the address data of an adjacent groove. (“Disk 5”)

Preferably, “Disk 1” may further have the following features. Specifically, the address region of each groove includes a common address data recording portion for storing frame data and band data, while the individual address data recording portions store track data of each groove. (“Disk 6”)

According to a second aspect of the present invention, there is provided an optical disk comprising: a recording area divided into a plurality of annular bands, each band being circumferentially divided into a plurality of sectors; and a plurality of grooves provided in each sector and serving as data-recording tracks. Each groove includes an address region in which data is recorded by in-phase wobbles, the address region being divided into a first address data recording portion and a second address data recording portion. In a selected groove, a sync pattern and address data of the selected groove are recorded in the first address data recording portion. In another groove adjacent to the selected groove, a sync pattern and address data thereof are recorded in the second address data recording portion. The sync patterns of these grooves have the same phase. (“Disk 7”)

Preferably, the above disk (“Disk 7”) may further have the following features. Specifically, the first address data recording portion records individual address data and common address data, the individual address data including track data, the common address data including frame data and band data. The second address data recording portion records individual address data including track data. (“Disk 8”)

According to a third aspect of the present invention, there is provided a method of reading data from “Disk 1” by using a radial push-pull technique. The method comprises the steps of: passing a beam along a groove; detecting address selection data recorded in the address selection data recording portion of the groove; and selecting one of the plurality of individual address data recording portions in accordance with the detected address selection data.

According to a fourth aspect of the present invention, there is provided an optical disk drive for reading address data from “Disk 1” by using a radial push-pull technique. The drive comprises: an optical head for scanning a groove of the disk by a beam; a detector for detecting address selection data recorded in the address selection data recording portion of the groove; and a selector for selecting one of the plurality of individual address data recording portions in accordance with the detected address selection data.

According to a fifth aspect of the present invention there is provided a method of reading data from “Disk 3” by using a radial push-pull technique. The method comprises the steps of: passing a beam along a land; detecting a double-wobbled resync pattern formed on the land, the resync pattern resulting from a combination of resync patterns of two adjacent grooves flanking the land; outputting a trigger signal in accordance with the detected resync pattern; and detecting an in-phase double-wobbled individual address data of the land in accordance with the trigger signal, the individual address data resulting from a combination of in-phase double wobbles formed in the two adjacent grooves.

According to a sixth aspect of the present invention, there is provided an optical disk drive for reading address data from “Disk 3” by using a radial push-pull technique. The drive comprises: an optical head for scanning a land of the disk by a beam; a resync detector for detecting a double-wobbled resync pattern formed on the land, the resync pattern resulting from a combination of resync patterns of two adjacent grooves flanking the land; a signal generator for outputting a trigger signal in accordance with the detected resync pattern; and an address detector for detecting an in-phase double-wobbled individual address data of the land in accordance with the trigger signal, the individual address data resulting from a combination of in-phase double wobbles formed in the two adjacent grooves.

According to a seventh aspect of the present invention, there is provided a method of reading data from “Disk 7” by a radial push-pull technique. The method comprises the steps of: passing a beam along a target groove, the beam having a diameter greater than a width of the target groove; generating a first detection signal and a second detection signal, the first detection signal resulting from a sync pattern formed in the target groove, the second detection signal resulting from sync patterns formed in adjacent grooves flanking the target groove; and detecting address data recorded in the target groove based on the first detection signal.

Preferably, the first detection signal is opposite in phase to the second detection signal.

According to an eighth aspect of the present invention, there is provided an optical disk drive for reading address data from “Disk 7” by using a radial push-pull technique. The drive comprises: an optical head for passing a beam along a target groove of the disk, the beam having a diameter greater than a width of the target groove; a signal generator for generating a first detection signal and a second detection signal, the first detection signal resulting from a sync pattern formed in the target groove, the second detection signal resulting from sync patterns formed in adjacent grooves flanking the target groove; and an address detector for detecting address data recorded in the target groove based on the first detection signal.

Other features and advantages of the present invention will become apparent from the detailed description given below with reference to the accompanying drawings.

### BRIEF DESCRIPTION OF THE DRAWINGS

FIG. 1 is a schematic plan view showing the format of an optical disk according to a first embodiment of the present invention;

FIG. 2 illustrates examples of in-phase double-wobbled formats for address selection data of the disk;

FIG. 3 illustrates resync formats of the disk and the push-pull signals resulting from the detection of these resync patterns;

FIG. 4 shows an example of a push-pull signal outputted upon reading the information recorded on a land of the disk;

FIG. 5 is a schematic view showing the components of an optical disk drive for reading data from the disk;

FIG. 6 is a timing chart illustrating the signal processing to be performed by an address decoder when address information is read from a groove of the disk of FIG. 1;

FIG. 7 is a timing chart illustrating the signal processing to be performed by the address decoder when address information is read from a land of the disk;

FIG. 8 is a schematic plan view showing the format of an optical disk according to a second embodiment of the present invention;

FIG. 9 shows an example of a push-pull signal outputted upon reading the information recorded on a land of the disk shown in FIG. 8;

FIG. 10 is a schematic plan view showing the format of an optical disk according to a third embodiment of the present invention;

FIG. 11 is a timing chart illustrating the data processing to be performed by the address decoder when the address information is read from a groove of the disk shown in FIG. 10;

FIG. 12 is a schematic plan view showing the format of an optical disk according to a fourth embodiment of the present invention;

FIG. 13A is a timing chart illustrating the data processing to be performed when the address information is read from e.g. the groove G(n) of the disk of FIG. 12;

FIG. 13B is a timing chart illustrating the data processing to be performed when the address information is read from e.g. the groove G(n−1) of the disk of FIG. 12;

FIG. 14 is a schematic plan view showing the format of an optical disk as related art;

FIG. 15 is a schematic diagram showing the format of a recording track of the disk shown in FIG. 14;

FIG. 16 is a schematic plan view showing the structure of an address segment;

FIG. 17 illustrates signal detection by a push-pull method;

FIG. 18 is a schematic plan view showing the in-phase double-wobbled format of an optical disk;

FIG. 19 illustrates an example of a push-pull signal outputted upon data-reading with respect to a land of the disk shown in FIG. 18; and

FIG. 20 is a schematic plan view showing the format of an optical disk in which the track pitch between the adjacent grooves is smaller than the diameter of the laser spot used for reading data.

### DETAILED DESCRIPTION OF THE PREFERRED EMBODIMENTS

Preferred embodiments of the present invention will be described below with reference to the accompanying drawings.

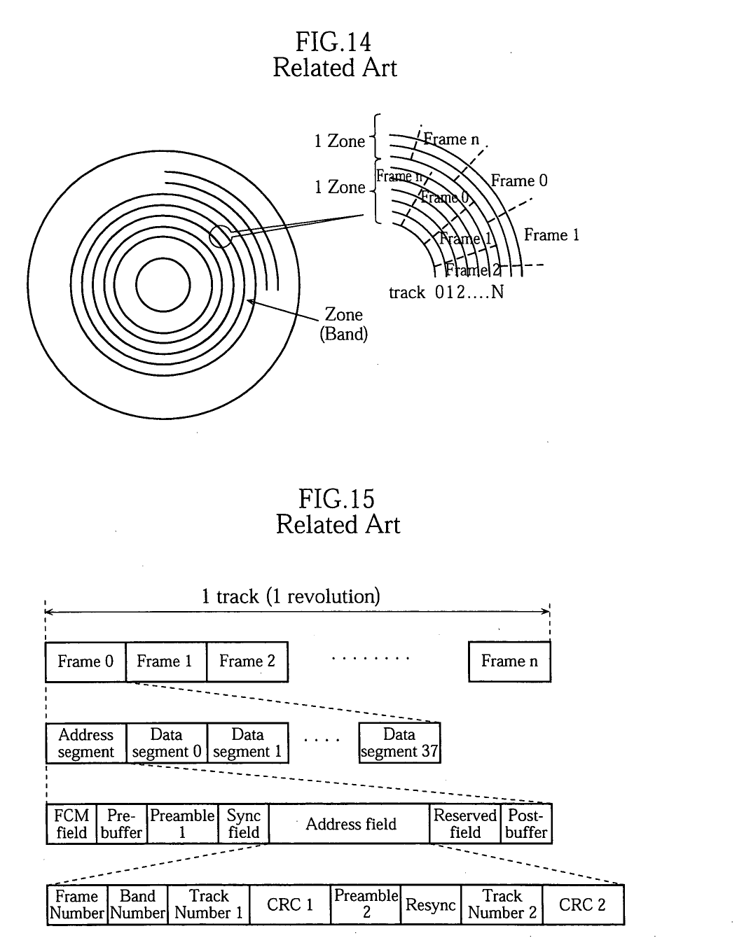

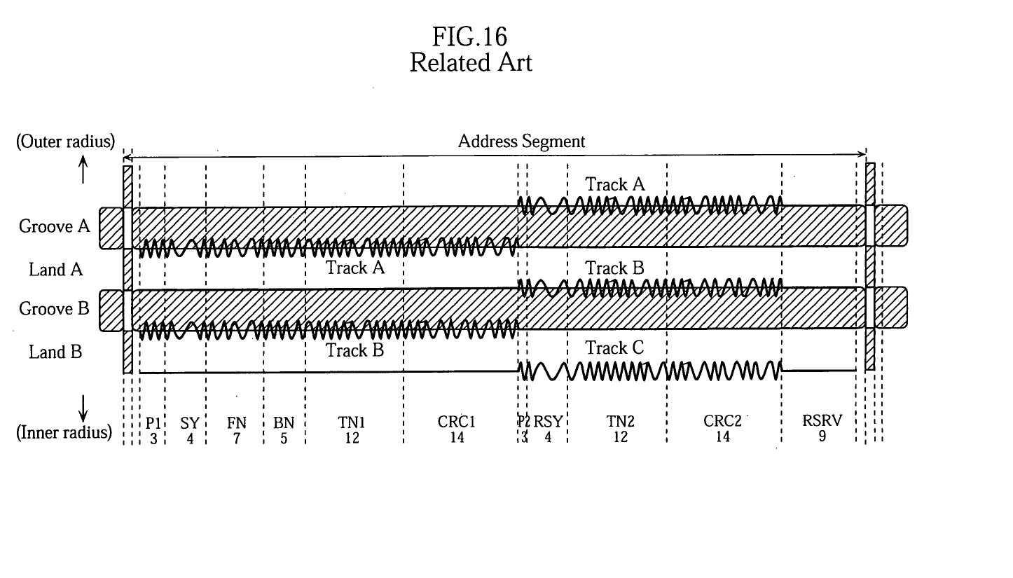

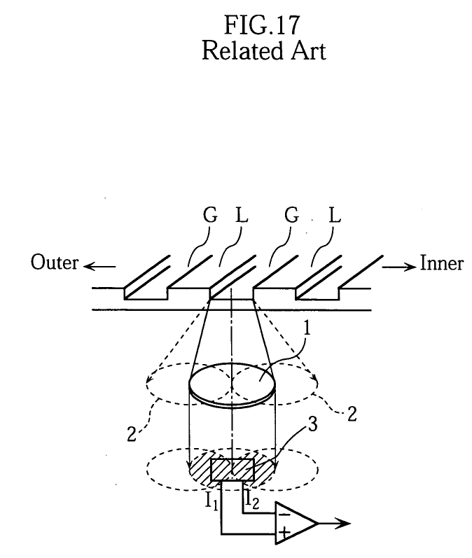

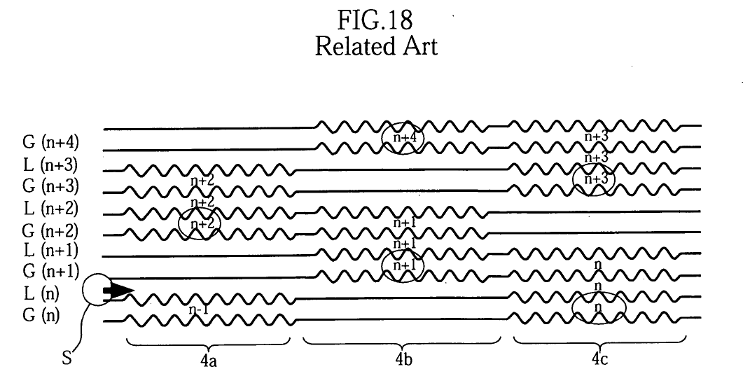

Optical disks according to the present invention have a recoding area in which data-recording tracks are provided by a groove/land configuration. The tracks may be arranged in a spiral or in concentric circles. As in the case shown in FIG. 14, the recording area is divided into annular bands each containing a prescribed number of tracks. In each band, the recording area is further divided into sectors, whereby each track in the band is also divided into smaller units called frames. As shown in FIG. 15, each frame is made up of an address segment and data segments following the address segment. The address segment permanently holds pre-recorded address information for the frame and other necessary information. The data segments provide area to which the user of the disk can write data. The address field in the address segment stores frame data (e.g. frame number), band data (e.g. band number), track data (e.g. track number), and so forth. As will become clear from the description below, the optical disk of the present invention is characterized by the data format of address information.

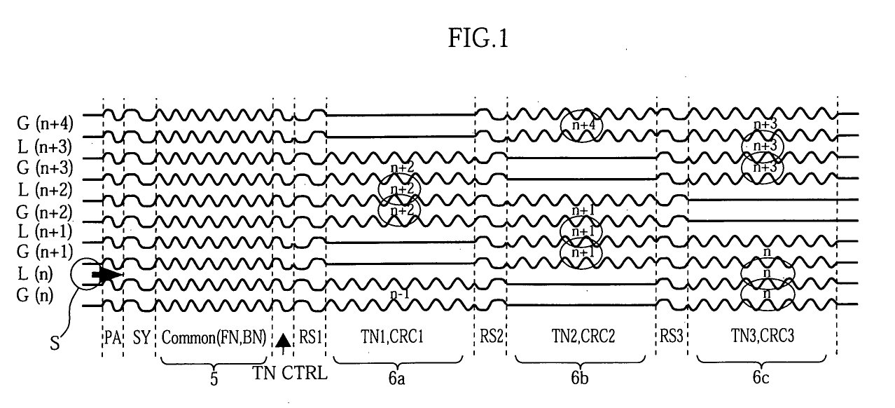

FIG. 1 schematically shows the data format of an optical disk according to a first embodiment of the present invention. The illustrated portions of grooves G and lands L are contained in the same band and the same sector. The grooves G(n)˜G(n+4) and the lands (n)˜(n+3) are arranged alternately in the vertical direction in the figure, which corresponds to a radial direction of the disk.

As shown in FIG. 1, each of the grooves G(n)˜(n+4) includes a preamble pattern PA, a sync pattern SY, a common address data recording portion 5, an address selection data recording portion TN CTRL, a first resync pattern RS1, a first individual address data recording portion 6a, a second resync pattern RS2, a second individual address data recording portion 6b, a third resync patter RS3, and a third individual address data recoding portion 6c. As illustrated, the preamble patterns PA for the respective grooves and lands are aligned in the radial direction of the disk, and so are the other parts mentioned above.

The grooves (n)˜(n+4) have the same in-phase double-wobble pattern for the preamble pattern PA, the sync pattern SY and the common address data recording portion 5. Accordingly, the lands (n)˜(n+3), flanked by the grooves (n)˜(n+4), have the same double-wobble pattern for the preamble pattern PA, the sync pattern SY and the common address data recording portion 5. The double wobbles of the common address data recording portion 5 represent a frame number FN and a band number BN that are common to all the illustrated tracks, i.e. the grooves (n)˜(n+4) and lands (n)˜(n+3).

The first˜third individual address data recording portions 6a˜6c for the respective grooves (n)˜(n+4) store double-wobbled address data (such as a track number and a CRC) in accordance with the rules described below.

Each of the grooves (n)˜(n+4) is provided with the individual address data of its own. As shown in FIG. 1, the address data (n) of the groove (n) is stored in the third portion 6c of the groove (n). The address data (n+1) of the groove (n+1) is stored in the second portion 6b of the groove (n+1). The address data (n+2) of the groove (n+2) is stored in the first portion 6a of the groove (n+2). The address data (n+3) of the groove (n+3) is stored in the third portion 6c of the groove (n+3). The address data (n+4) of the groove (n+4) is stored in the second portion 6b of the groove (n+4). In this case, the portion to store the individual address data for the grooves (n)˜(n+4) cyclically shifts as 6c→6b→6a→6c→6b.

As noted above, the individual address data (n) of the groove (n) is stored in the third portion 6c of the groove (n). According to the present embodiment, the same address data (n) is also recorded in the third portion 6c of the (n+1)th groove by the double-wobble format, as shown in FIG. 1. Consequently, the third portion 6c of the in-between land (n) is to store the same individual address data (n).

The above rule applies to the other individual address data. Specifically, the individual address data (n+1) of the groove (n+1) is recorded in the second portion 6b of the (n+2)th groove (and hence in the second portion 6b of the in-between land (n+1)). The individual address data (n+2) of the groove (n+2) is recorded in the first portion 6a of the (n+3)th groove (and hence in the first portion 6a of the in-between land (n+2)). The individual address data (n+3) of the groove (n+3) is recorded in the third portion 6c of the (n+4)th groove (and hence in the third portion 6c of the in-between land (n+3)).

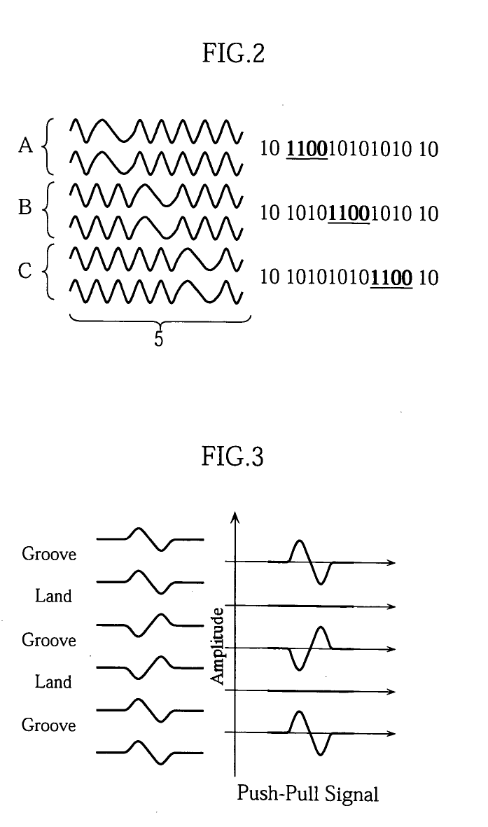

With the above arrangement, each groove is formed with two pieces of individual address data, that is, the address data of its own and the address data of another groove. Thus, in performing data reading with respect to any one of the grooves, the two pieces of individual address data are detected by the push-pull method. To enable the selection between the two, address selection data is recorded in the recording portion TN CTRL of each groove. Referring to FIG. 2, the address selection data is presented by one of three different patterns A˜C of in-phase double wobbles. As illustrated, the respective patterns A˜C have a part of a relatively low frequency (longer wave length) at different locations so that they are differentiable from each other. The first pattern A represents an instruction to select the address data stored in the first portion 6a, the second pattern B represents an instruction to select the address data stored in the second portion 6b, and the third pattern C represents an instruction to select the address data stored in the third portion 6c. As readily understood, the TN CTRL portion of the groove (n+1), for example, is provided with the second pattern B, since the individual address data of the groove (n+1) is recorded in the second recording portion 6b.

The first, the second and the third resync patterns RS1˜RS3, produced by in-phase double wobbles, are disposed adjacent to the leading (upstream) ends of the first, the second and the third individual address data recording portions 6a˜6c, respectively. The rule for these resync patterns are as follows.

Taking the groove (n) for example, the first and the third recording portions 6a, 6c are provided with individual address data (of the groove itself and another groove). Thus, the corresponding resync patterns RS1, RS3 are made to comprise the identical in-phase double wobbles. The second recording portion 6b, on the other hand, is provided with no individual address data. Thus, the corresponding resync pattern RS2 is to comprise in-phase double wobbles which have the opposite phase in relation to the wobbles of the resync patterns RS1, RS3. As seen from FIG. 1, the resync patterns RS1˜RS3 of the other grooves (n+1)˜(n+4) follow the same rule.

As a result of the above arrangement, each of the lands (n)˜(n+3) has one in-phase resync pattern and two out-of-phase resync patterns. Taking the land (n) for example, the first and the second resync patters RS1, RS2 are out of phase, while the third resync pattern RS3 is in phase. It should be noted that each of the out-of-phase patterns RS1, RS2 is adjacent to the single-wobbled individual data recording portion 6a or 6b of the land (n), while the in-phase pattern RS3 is adjacent to the double-wobbled portion 6c. As seen from FIG. 1, this holds for the other lands (n+1)˜(n+3). As illustrated in FIG. 3, the output level of a push-pull signal is non-zero for an in-phase resync pattern, while it is zero for an out-of-phase resync pattern.

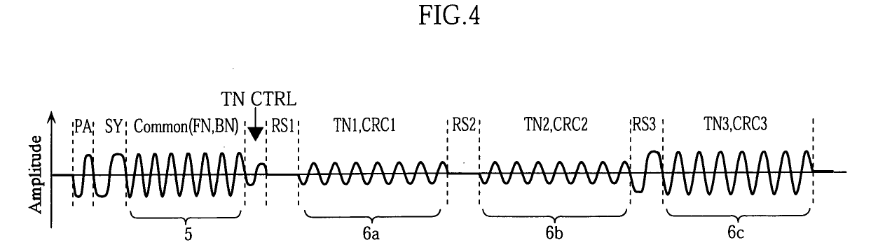

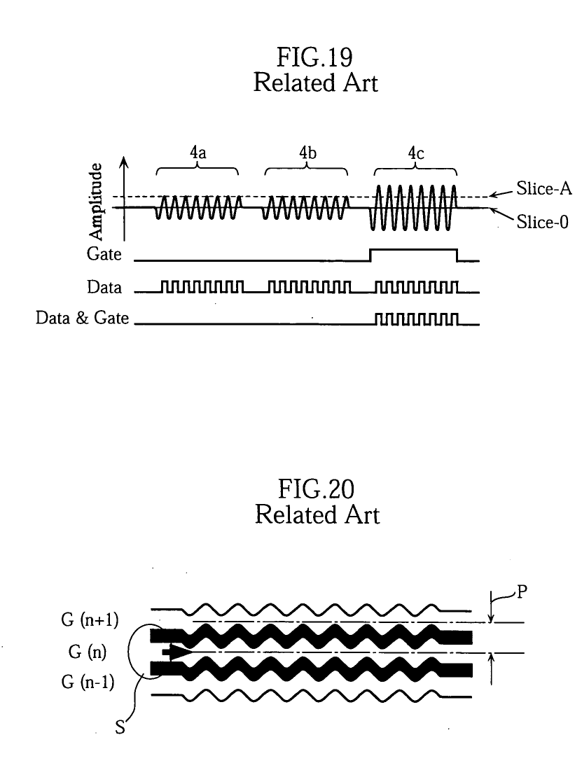

FIG. 4 shows the wave form of a push-pull signal resulting from the data-reading with respect to the land (n). As illustrated, the output level of the signal is zero for the first and the second resync patterns RS1, RS2, while it is non-zero for the third resync pattern RS3. Thus, by using the non-zero signal as a trigger, the individual address data in the third recording portion 6c of the land (n) can be read out. In this manner, there is no need to use a complicated circuit for producing more than one slice level to select the desired signal (see FIG. 19).

In accordance with the first embodiment, the track information (TN) and the CRC of the grooves are stored in two of the individual address data recording portions 6a˜6c, while the common address information (FN, BN) is stored in a region separate from the recording portions 6a˜6c. This format saves data storage space on the disk in comparison to another possible format in which the address information (FN, BN) is stored together with the individual address data (TN) and the CRC in two of the recording portions 6a˜6c.

In the above embodiment, each track includes three individual address data recording portions. It should be noted, however, that the present invention is not limited to this example. Four or more individual address data recording portions may be provided for each of the tracks.

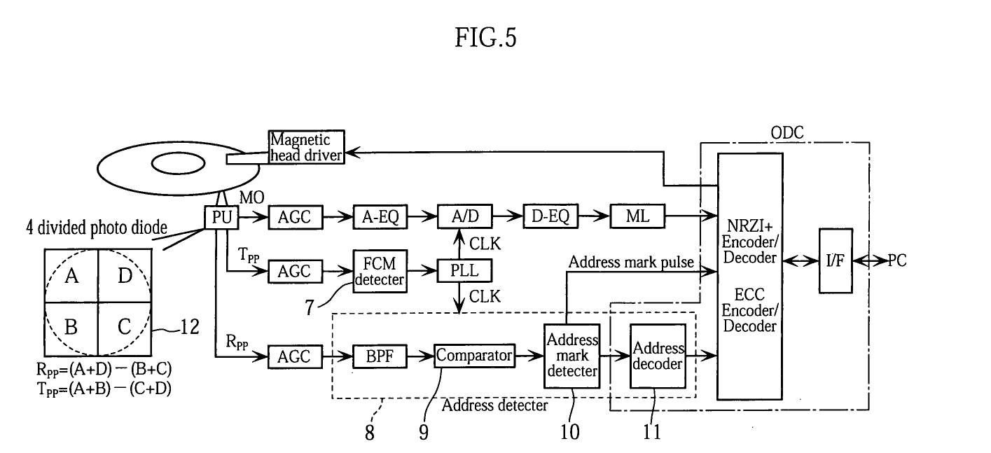

Reference is now made to FIG. 5 illustrating a disk drive for writing data to and reading data from the optical disk described above.

The disk drive includes an optical head (pickup) PU for reading the information recorded on the optical disk. The read-out data is sent to an optical disk controller ODC via an analog gain controller AGC, an analog equalizer A-EQ, an analog-digital converter A/D, a digital equalizer D-EQ, and a maximum likelihood decoder ML. Tangential push-pull signals Tpp, produced in the optical head PU, are sent to a phase-locked loop PLL via an analog gain controller AGC and a fine clock mark detector 7. Thus, clock signals are generated based on the detection of the fine clock marks (not shown in FIG. 1) formed in the tracks on the disk. Radial push-pull signals, produced in the optical head PU, are sent to an address detector 8 via an analog gain controller AGC. The address detector 8 includes a band-pass filter BPF, a comparator 9, and an address mark detector 10. Signals from the address mark detector 10 are sent to an address decoder 11 for determination of the address information. The optical head PU includes a 4-divisional detector 12 with four quarter-circle detection areas A˜D, as shown in FIG. 5. Signals obtained by the detector 12 are calculated in accordance with a known algorithm, to provide the above-mentioned tangential push-pull signals (Tpp) and radial push-pull signals (Rpp).

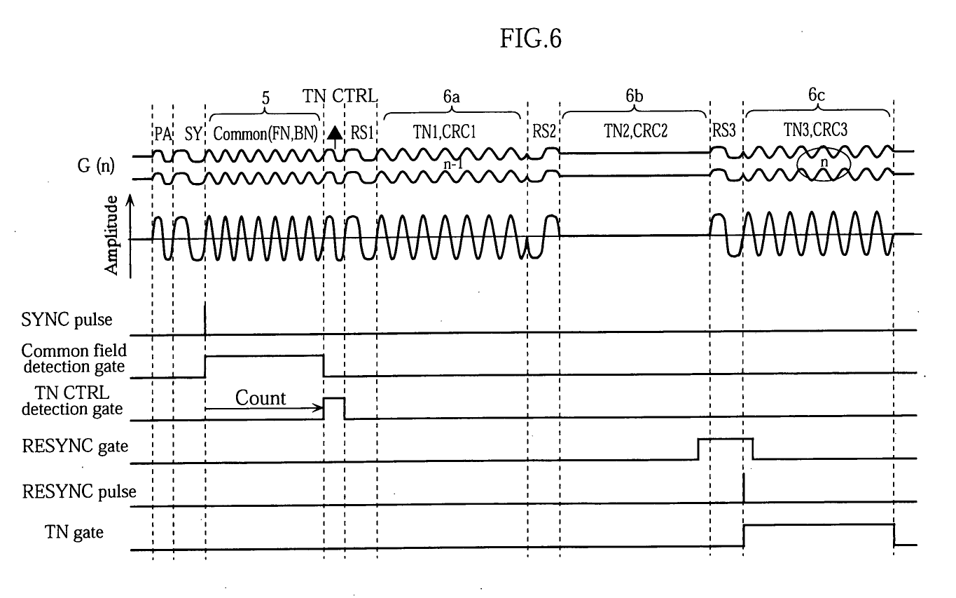

As noted above, the address information is obtained based on a push-pull signal. To this end, the address decoder 11 performs prescribed signal processing to be described below with reference to the timing chart in FIG. 6. In the illustrated example, the address information (n) of the groove G(n) is read.

The address decoder 11 detects the sync SY, thereby recognizing that the following data contains the address information. Then, using a sync detection pulse as a trigger, the decoder opens a common address detection gate to detect the common address data recorded in the recording portion 5 of the groove. Upon detecting the address selection data (TN CTRL), the decoder determines which individual address data recording portion (6a˜6c) records the desired address data. (The gate for detection of the selection data TN CTRL is opened at an appropriate time based on the clock count measured from the sync pulse.) Based on the determination, a resync gate is opened for a certain period of time. During this, a resync detection pulse is detected, whereby a gate for detection of the desired individual address data is opened. In the example shown in FIG. 6, a pulse for the third resync RS3 is generated, and the address data in the third recording portion 6c is detected. In this manner, only the selected piece of individual address data is detected. Therefore, the address data detection can be performed more reliably than when more than one piece of individual address data needs to be detected.

The detection of the address selection data TN CTRL is not always successful. If the detection fails, the following process is performed. As shown in FIG. 6, the wobbled patterns for the resync RS1 and the resync RS3 are the same, whereas the wobbled pattern for the resync RS2 is opposite in phase to these two patterns. Due to this difference, it is possible to detect the address data in the first and the third portions 6a, 6c, with the detection of the resync patterns RS1, RS3 used as a trigger. Then, the track numbers carried by the respective pieces of address data are compared, to determine which address data is for the target groove (the address data to be selected carries the greater track number). With such a scheme, the address information is reliably detected.

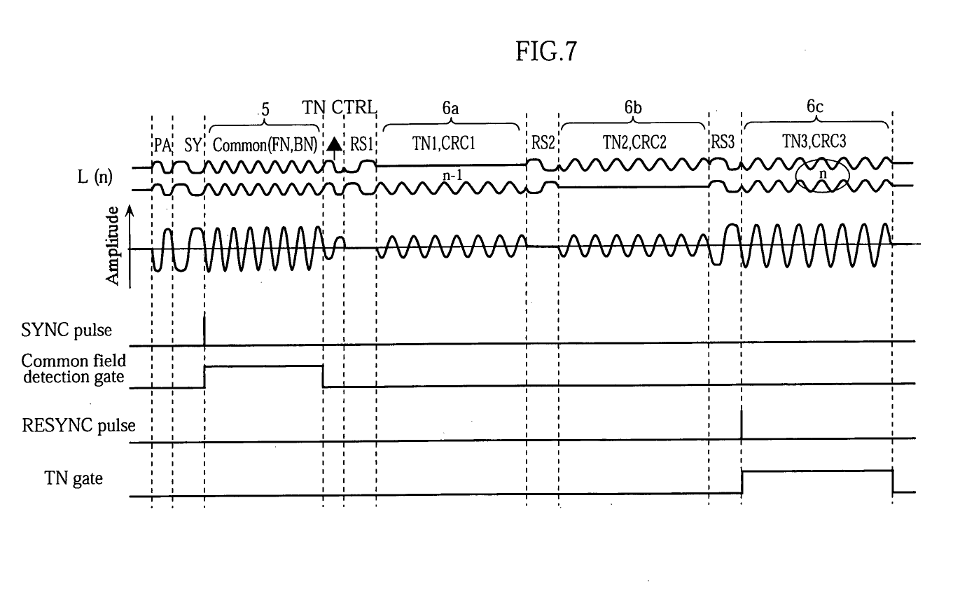

Referring to FIG. 7, the address data detection for a land will be described below.

First, the address decoder 11 detects the sync SY, thereby recognizing that the following data relates to the address data of the land (in the illustrated example, the land (n)). By using a sync detection pulse as a trigger, the decoder 11 opens a common address detection gate for detection of the common address data recorded in the portion 5.

Then, the detection of the resync patterns is performed. In the illustrated example, the first resync pattern RS1 and the second resync pattern RS2 are provided by the out-of-phase wobbles, whereby the signal output level by the push-pull method is zero. On the other hand, the third resync pattern RS3 is provided by the in-phase wobbles, whereby the signal output level is non-zero. By using a resync detection pulse as a trigger, the decoder 11 opens a gate for detection of the address data recorded in the third individual address data recording portion 6c. The address selection data TN CTRL is not used for reading data from a land.

In the above manner, only the desired individual address data can be detected, with the resync pulse used as a trigger. Thus, there is no need to prepare a complicated circuit or control system for setting different slice levels (see FIG. 19) to single out the desired address information.

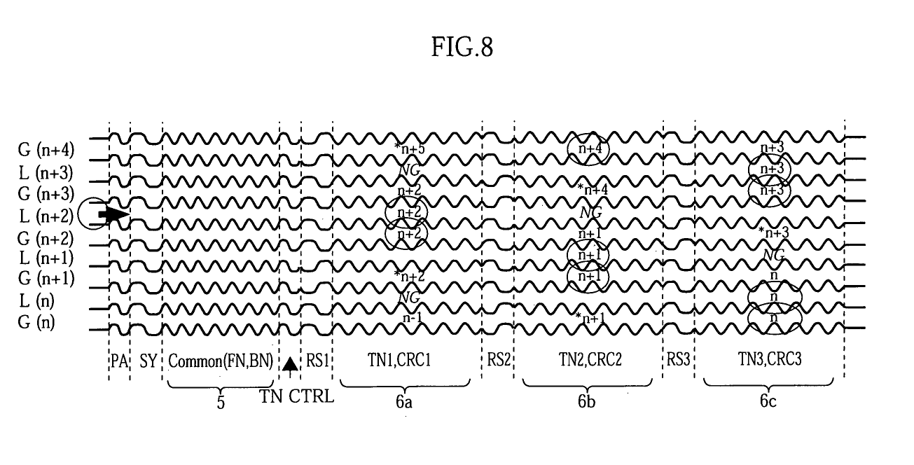

FIG. 8 shows the format of an optical disk according to a second embodiment of the present invention. The format of FIG. 8 is the same as that of FIG. 1 except for the following features.

The format shown in FIG. 1 includes several “data-vacant” individual address data recording portions at which no address data is recorded. Specifically, such data-vacant portions are the second portion 6b of the groove G(n), the first portion 6a of the groove G(n+1), the third portion 6c of the groove G(n+2), the second portion 6b of the groove G(n+3), and the first portion 6a of the groove G(n+4). In the format of FIG. 8, however, each of these vacant portions is formed with an in-phase double-wobbled pattern. Specifically, the second portion 6b of the groove G(n) is formed with a pattern * n+1, the first portion 6a of the groove G(n+1) with a pattern *n+2, the third portion 6c of the groove G(n+2) with a pattern *n+3, the second portion 6b of the groove G(n+3) with a pattern * n+4, and the first portion 6a of the groove G(n+4) with a pattern *n+5, where a pattern * n+x is equal to a pattern n+x with the reversed phase.

With the disk shown in FIG. 8, the address data detection for each groove is performed in the same manner as described above with reference to FIG. 6. Also, the address data detection for each land is performed in the same manner as described above with reference to FIG. 7.

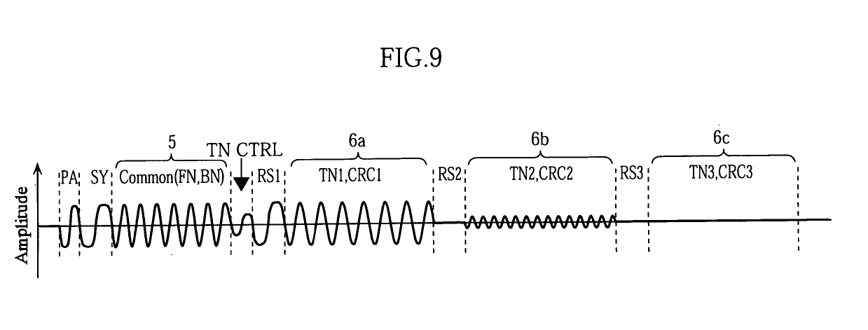

The disk format of the second embodiment has the following advantage. FIG. 9 shows the wave form of a push-pull signal outputted in performing data-reading with respect to the land L(n+2) of the disk. As seen from the figure, the amplitude of the push-pull signal for the first individual address data recording portion 6a is greater than the amplitude of the push-pull signal for the second individual address data recording portion 6b. This is because the first portion 6a is formed with in-phase double wobbles (hence the output signal is strong), whereas the second portion 6b is not. More specifically, the double wobbles of the second portion 6b of the land L(n+2) are made up of an upper half coming from the format * n+4 of the groove G(n+3) and a lower half coming from the format n+1 of the groove G(n+2). The upper half and the lower half are not in phase, and do not completely cancel out each other. Accordingly, the resultant push-pull signal from the second portion 6b is weaker than the signal from the first portion 6a, but not zero. As noted above, each of the individual address data recording portions 6a˜6c is provided with the CRC for error checking. Thus, the output pattern of the second portion 6b of the land L(n+2) is regarded as non-valid (NG). The push-pull signal from the third potion 6c is zero since the upper half and the lower half of the wobbled pattern completely cancel out each other. Thus, it is easy to detect the individual address data recorded in the first portion 6a.

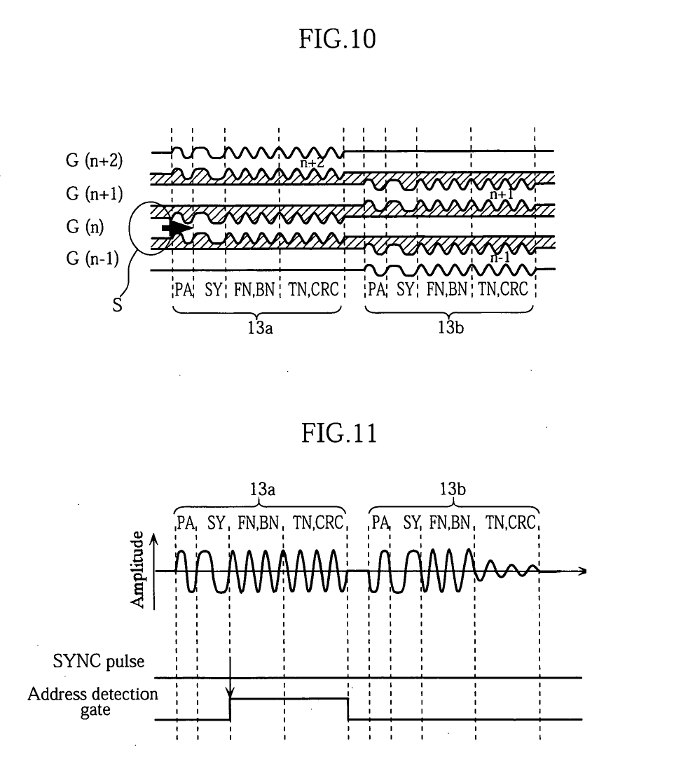

FIG. 10 shows the format of an optical disk according to a third embodiment of the present invention. The disk of this embodiment has narrow lands so that data is not recorded on the lands. As illustrated, each groove G(n−1)˜(n+2) includes a first address recording portion 13a and a second address recording portion 13b. For the grooves G(n) and G(n+2) (n is an odd number, for example), the first recording portion 13a is provided with in-phase double wobbles representing a preamble PA, a sync SY, and address information such as a frame number FN, a band number BN and a track number TN. The CRC may be added optionally. For the grooves G(n−1) and G(n+1), the second recording portion 13b is provided with in-phase double wobbles representing the same kinds of data mentioned above for the grooves G(n) and G(n+2). As readily understood, data common to the first and the second recording portions 13a, 13b (i.e., PA, SY, FN, BN) is represented by the same in-phase wobbles having the same phase.

FIG. 11 shows a push-pull signal resulting from the data reading with respect to the groove G(n) (note that the laser spot S has a diameter which is larger than the track pitch, as shown in FIG. 10), while also showing a timing chart for the address decoder. The push-pull signal is divided into a first part and a second part, where the first part results from the double wobbles formed in the first recording portion 13a of the groove G(n), and the second part results from the upper wobble formed in the second recording portion 13b of the groove G(n−1) and the lower wobble formed in the second recording portion 13b of the groove G(n+1). As illustrated in the figure, the first sync SY output (depicted under the right brace 13a) and the second sync SY output (depicted under the left brace 13b) are opposite in phase, and therefore distinguishable.

Thus, for the grooves G(n) and G(n+2), an address detection gate is opened, with the first sync SY output used as a trigger, so that only the address data recorded in the first recording portion 13a can be read. Likewise, for the grooves G(n−1) and G(n+1), an address detection gate is opened, with the second sync SY output used as a trigger so that only the address data recorded in the second recording portion 13b can be read.

According to the third embodiment described above, it is possible to read the address information properly (i.e. without causing crosstalk) even when use is made of a laser beam whose diameter is greater than the track pitch.

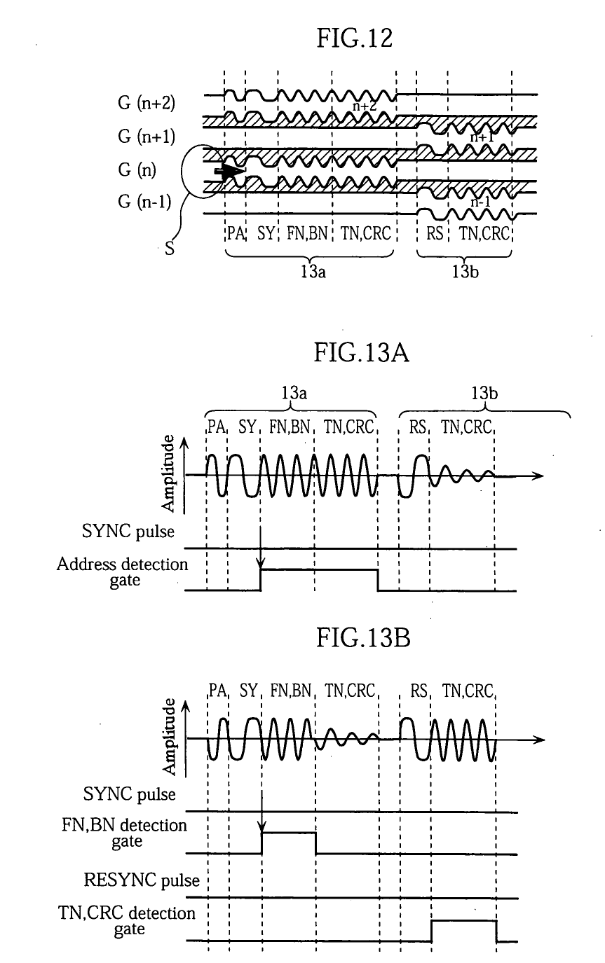

FIG. 12 shows the format of an optical disk according to a fourth embodiment of the present invention. The disk of the fourth embodiment is a modification of the disk of the third embodiment (FIG. 10). As shown in the figure, the first address data recording portion 13a records a preamble PA, a sync SY, common address data (such as a frame number and a band number), and individual address data (such as a track number and a CRC). The second address data recording portion 13b records a resync and individual address data such as a track number and a CRC. As illustrated, in the grooves G(n) and G(n+2), only the first address recording portion 13a is used for address data storage, while in the grooves G(n−1) and G(n+1), only the second address recording portion 13b is used for address data storage.

FIG. 13A shows a push-pull signal resulting from the data reading with respect to the groove G(n) or G(n+2), while also showing a timing chart for the address decoder. In this case (where data is being read from the groove G(n)), it is possible to detect the common address data (FN, BN) and individual address data (TN, CRC) by opening an address detection gate for an appropriate time by using the sync SY output as a trigger.

FIG. 13B shows a push-pull signal resulting from the data reading with respect to e.g. the groove G(n−1), while also showing a timing chart for the address decoder. In this case, two detection gates need to be opened for reading the desired address information. Specifically, a first detection gate (FN, BN) is opened by the trigger of the sync SY output to detect the frame number FN and the band number BN. Then, a TN-CNC detection gate is opened by the trigger of the resync RS output to detect the track number and the CRC.

In the above case, the push-pull output of the preamble PA, the sync SY and the common address data (FN, BN) for the first recording portion 13a of the groove G(n−1) is valid, and has the opposite phase to the counterpart of the grooves G(n) and G(n+2). This is because the push-pull output for the groove G(n−1) results from the wobbles of the two adjacent grooves flanking the groove G(n−1). On the other hand, the push-pull output of the individual address data (TN, CRC) for the first recording portion 13a of the groove G(n−1) is weak and irregular due to the interference of the individual address data for the two flanking grooves. Turning now to the second recording portion 13b, the resync RS, the track number TN and the CRC are properly detected in accordance with the double wobbles formed in the second portion 13b of the groove G(n−1). The sync SY and the resync RS are opposite in phase and therefore distinguishable.

According to the fourth embodiment, the common address data is stored only in the first recording portion 13a, as opposed to the third embodiment, whereby the data storage space is saved.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. An optical disk comprising:
a recording area divided into a plurality of annular bands, each band being circumferentially divided into a plurality of sectors;
a plurality of grooves provided in each sector and serving as data-recording tracks; and
a plurality of lands provided in said each sector and serving as data-recording tracks, the lands alternating with the grooves radially of the disk;
wherein each groove comprises an address region in which data is recorded by in-phase double wobbles, the address region including an address selection data recording portion and a plurality of individual address data recording portions arranged along said each groove, the address selection data recording portion storing data to select one of the individual address data recording portions for reading individual address data from the selected portion.

2. The optical disk according to claim 1, wherein the plurality of grooves comprise a first groove, a second groove adjacent to the first groove, and a third groove adjacent to the second groove, the plurality of individual address data recording portions of these grooves comprising three individual address data recording portions,
wherein in the first groove, one of the three individual address data recording portions stores address data of the first groove,
wherein in the second groove, one of the three individual address data recording portions stores the address data of the first groove, and another individual address data recording portion stores address data of the second groove,
wherein in the third groove, one of the three individual address data recording portions stores the address data of the second groove, and another individual address data recording portion stores address data of the third groove,
wherein the individual address data recording portion of the first groove that stores the address data of the first groove is adjacent radially of the disk to the individual address data recording portion of the second groove that stores the address data of the first groove, and
wherein the individual address data recording portion of the second groove that stores the address data of the second groove is adjacent radially of the disk to the individual address data recording portion of the third groove that stores the address data of the second groove.

3. The optical disk according to claim 2, wherein each groove comprises resync patterns adjacent to the three individual address data recording portions, and wherein the resync patterns corresponding to the two individual address data recording portions in which address data is stored are opposite in phase to the resync pattern corresponding to the remaining individual address data recording portion.

4. The optical disk according to claim 3, wherein the remaining individual address data recording portion is formed with an in-phase double-wobbled pattern which is irrelevant to the address data stored in said two individual address data recording portions.

5. The optical disk according to claim 4, wherein the irrelevant in-phase double-wobbled pattern of each groove is opposite in phase to the address data of a groove adjacent to said each groove.

6. The optical disk according to claim 1, wherein the address region of each groove includes a common address data recording portion for storing frame data and band data, while the individual address data recording portions store track data of said each groove.

7. An optical disk comprising:
a recording area divided into a plurality of annular bands, each band being circumferentially divided into a plurality of sectors; and
a plurality of grooves provided in each sector and serving as data-recording tracks;
wherein each groove includes an address region in which data is recorded by in-phase wobbles, the address region being divided into a first address data recording portion and a second address data recording portion,
wherein in a selected groove, a sync pattern and address data of the selected groove are recorded in the first address data recording portion,
wherein in another groove adjacent to the selected groove, a sync pattern and address data of said another groove are recorded in the second address data recording portion,
wherein the sync patterns of the grooves have a same phase.

8. The optical disk according to claim 7, wherein the first address data recording portion records individual address data and common address data, the individual address data including track data, the common address data including frame data and band data, and wherein the second address data recording portion records individual address data including track data.

9. A method of reading data from an optical disk according to claim 1 by using a radial push-pull technique, the method comprising the steps of:
passing a beam along a groove;
detecting address selection data recorded in the address selection data recording portion of the groove; and
selecting one of the plurality of individual address data recording portions in accordance with the detected address selection data.

10. An optical disk drive for reading address data from an optical disk according to claim 1 by using a radial push-pull technique, the drive comprising:
an optical head for scanning a groove of the disk by a beam;
a detector for detecting address selection data recorded in the address selection data recording portion of the groove; and
a selector for selecting one of the plurality of individual address data recording portions in accordance with the detected address selection data.

11. A method of reading data from an optical disk according to claim 3 by using a radial push-pull technique, the method comprising the steps of:
passing a beam along a land;
detecting a double-wobbled resync pattern formed on the land, the resync pattern resulting from a combination of resync patterns of two adjacent grooves flanking the land;
outputting a trigger signal in accordance with the detected resync pattern; and
detecting an in-phase double-wobbled individual address data of the land in accordance with the trigger signal, the individual address data resulting from a combination of in-phase double wobbles formed in the two adjacent grooves.

12. An optical disk drive for reading address data from an optical disk according to claim 3 by using a radial push-pull technique, the drive comprising:
an optical head for scanning a land of the disk by a beam;
a resync detector for detecting a double-wobbled resync pattern formed on the land, the resync pattern resulting from a combination of resync patterns of two adjacent grooves flanking the land;
a signal generator for outputting a trigger signal in accordance with the detected resync pattern; and
an address detector for detecting an in-phase double-wobbled individual address data of the land in accordance with the trigger signal, the individual address data resulting from a combination of in-phase double wobbles formed in the two adjacent grooves.

13. A method of reading data from an optical disk according to claim 7 by a radial push-pull technique, the method comprising the steps of:
passing a beam along a groove, the beam having a diameter greater than a width of said groove;
generating a first detection signal and a second detection signal, the first detection signal resulting from a sync pattern formed in said groove, the second detection signal resulting from sync patterns formed in adjacent grooves flanking said groove; and
detecting address data recorded in said groove based on the first detection signal.

14. The method according to claim 13, wherein the first detection signal is opposite in phase to the second detection signal.

15. An optical disk drive for reading address data from an optical disk according to claim 7 by using a radial push-pull technique, the drive comprising:
an optical head for passing a beam along a groove of the disk, the beam having a diameter greater than a width of said groove;
a signal generator for generating a first detection signal and a second detection signal, the first detection signal resulting from a sync pattern formed in said groove, the second detection signal resulting from sync patterns formed in adjacent grooves flanking said groove; and
an address detector for detecting address data recorded in said groove based on the first detection signal.
